(19) United States
(12) Patent Application Publication
(10) Pub. No.: US 2010/0140904 A1
(43) Pub. Date: Jun. 10, 2010

(54) Crash Pad for Mounting Airbag for Vehicles

(75) Inventors: Hyeong Ho CHOI, Gwangmyeong-si (KR); Yong Sun KIM, Namyangju-si (KR); Jun Yeol CHOI, Seoul (KR)

Correspondence Address: MORGAN, LEWIS & BOCKIUS LLP (SF), One Market, Spear Street Tower, Suite 2800, San Francisco, CA, 94105, US

(73) Assignees: Hyundai Motor Company, Seoul (KR); Kia Motors Corporation, Seoul (KR)

(21) Appl. No.: 12/556,344

(22) Filed: Sep. 9, 2009

(30) Foreign Application Priority Data
Dec. 4, 2008 (KR) 10-2008-0122423

(51) Int. Cl. B60R 21/215

(52) U.S. Cl. 280/728.3

(57) ABSTRACT

A crash pad for mounting an airbag for a vehicle includes a base layer made of a hard material and an outer cover layer made of a soft material. An opening is formed in the base layer, and a mounting housing is formed integrally with the base layer. An airbag door is coupled at one end thereof to the base layer. In the crash pad, the airbag mounting housing is integrated into the crash pad, thus reducing manufacturing costs. Further, the airbag door is separately installed, and a cutting operation is not required, so that the opening force of an airbag cushion is not reduced, and the opening direction of the cushion does not deviate from a predetermined direction.

### CROSS-REFERENCE TO RELATED APPLICATIONS

The present application claims priority to Korean Patent Application Number 10-2008-0122423 filed Dec. 4, 2008, the entire contents of which application is incorporated herein for all purpose by this reference.

### BACKGROUND OF THE INVENTION

1. Field of the Invention

The present invention relates to a crash pad for mounting an airbag for a vehicle which has an airbag therein, among general crash pads forming the upholstery in vehicles.

2. Description of Related Art

Recently, as demands for the safety of vehicles have increased, various kinds of airbags have been mounted to vehicles. Especially, a crash pad in a vehicle has an airbag therein. In the event of a vehicle collision, an airbag cushion is inflated to the outside of the crash pad and deployed, thus protecting a passenger's head and chest.

Meanwhile, various technologies have been proposed to mount an airbag to the interior of the crash pad. According to one of the technologies, part of the crash pad forming an airbag door comprises a panel which is made of a soft material. When an airbag cushion is deployed, the soft panel is cut, so that the cushion inflates to the outside.

However, the soft panel is problematic in that it is not easy to cut because of its tenacity, so that the opening force of the cushion must be strong. In the case where the inflation of the cushion is hindered by the soft panel, an opening direction may be deviated or an airbag housing may be deformed.

Further, the manufacturing cost of the soft panel is high, so that a high cost is spent on mounting the airbag.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a crash pad for mounting an airbag for a vehicle, in which an airbag housing is integrally provided on the crash pad itself and an airbag door is separately installed, thus preventing the opening force of an airbag cushion from being reduced, stabilizing the opening direction, and reducing manufacturing costs.

In an aspect of the present invention, the crash pad for mounting an airbag for a vehicle, may include a base layer made up of a first material and mounted to a vehicle body, wherein the base layer includes a flat portion and an opening, an outer cover layer made up of a second material and covering the flat portion and the opening of the base layer so as to fasten the flat portion of the base layer to the outer cover layer, a mounting housing extending from the flat portion of the base layer to form the opening and accommodate the airbag therein, and an airbag door disposed between the mounting housing and the outer cover layer, the airbag door including at least a rotary plate pivotally coupled to the base layer to close the opening, wherein the airbag door is configured to cut and open the outer cover layer when the airbag inflates to push the airbag door, wherein the first material is harder than the second material.

The first material for the base layer may include polypropylene or polyethylene. The second material for the outer cover layer may include polyurethane.

A support portion may connect the flat portion and the mounting housing so as to prevent undesirable movement of the mounting housing when the airbag is deployed.

A mounting hole may be formed in an end portion of the mounting housing so as to mount the airbag to the mounting housing, wherein a hook is installed to the airbag in a lateral side thereof and configured to be coupled to the mounting hole of the mounting housing.

A bracket may be formed to connect a lower end portion of the airbag to a cowl cross member.

In the other aspect of the present invention, a first end portion of the one of the at least a rotary plate door may be pivotally coupled to a rotation groove formed between the mounting housing and the flat portion of the base layer to control an intermediate angle between the flat portion and the mounting housing with respect to a rotation center of the first end portion, wherein a locking protrusion is provided on the first end portion in such a way as to protrude out of the rotation groove and configured to be selectively engaged with the flat portion or the mounting housing, so that the locking protrusion is stopped by the mounting housing when the airbag door opens, thus controlling an opening angle of the airbag door.

An extension lever may be included to extend from the first end portion to be connected with the one of the at least a rotary plate with a predetermined angle, wherein a stopper protrusion is formed on an end portion of the extension lever and is selectively engaged with the flat portion according a rotation of the airbag door

In another aspect of the present invention, a second end portion of the one of the rotary plates may be inserted between the flat portion of the base layer and the outer cover layer to be in close contact with the outer cover layer.

In further another aspect of the present invention, the other of the at least a rotary plate may include a first end portion pivotally coupled to the base layer, the one and the other of the at least a rotary plates being detachably coupled each other, wherein the first end of the other of the at least a rotary plate is pivotally coupled to a rotation groove formed between to the mounting housing and the flat portion of the base layer to control an intermediate angle between the flat portion and the mounting housing with respect to a rotation center of the first end portion, and wherein a locking protrusion is provided on the first end portion in such a way as to protrude out of the rotation groove and configured to be selectively engaged with the flat portion or the mounting housing, so that the locking protrusion is stopped by the mounting housing when the airbag door opens, thus controlling an opening angle of the airbag door.

An extension lever may be included to extend from the first end portion to be connected with the other of the at least a rotary plate with a predetermined angle, wherein a stopper protrusion is formed on an end portion of the extension lever and is selectively engaged with the flat portion according a rotation of the airbag door

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a perspective view illustrating an exemplary crash pad for mounting an airbag for vehicles according to the present invention.

FIG. 2 is a sectional view taken along line A-A of FIG. 1 to show the crash pad for mounting the airbag for vehicles.

FIG. 3 is a sectional view illustrating an airbag door included in an exemplary crash pad for mounting the airbag for vehicles shown in FIG. 2 according to the present invention.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

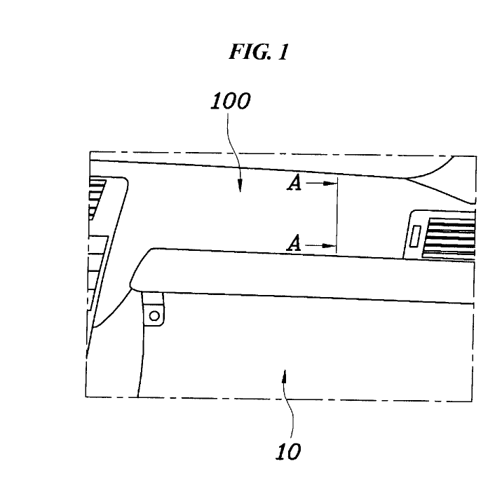

FIG. 1 is a perspective view illustrating a crash pad for mounting an airbag for vehicles according to various embodiments of the present invention. The crash pad 100 is provided in the interior of a vehicle, thus forming an interior panel, with a glove box 10 generally installed to the lower end of the crash pad 100. The airbag is accommodated in the crash pad 100, and an airbag cushion is deployed to the outside in the event of a vehicle collision, thus protecting a passenger's head and chest. Thus, normally, the crash pad 100 must stably support the airbag therein without exposing the airbag to the outside.

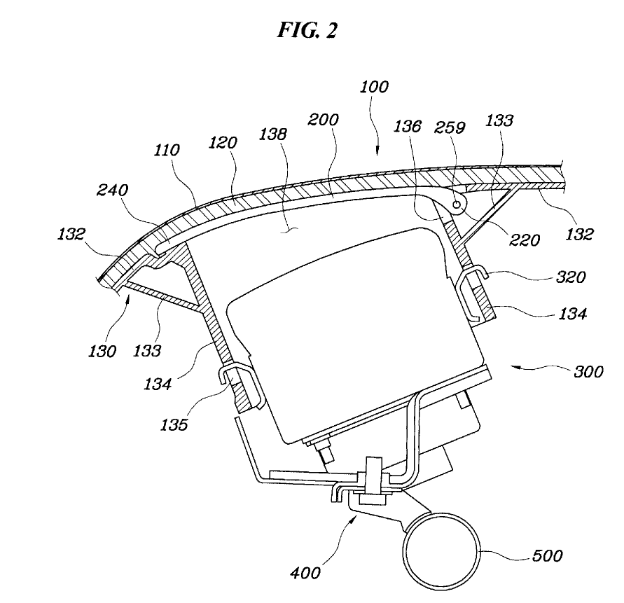

FIG. 2 is a sectional view taken along line A-A of FIG. 1 to show the crash pad for mounting the airbag for vehicles. The crash pad 100 for mounting the airbag according to various embodiments of the present invention includes a base layer 130 and an outer cover layer 120. The base layer 130 is formed using a hard material and coupled to a vehicle body. The outer cover layer 120 is provided to cover the outer surface of the base layer 130 and formed using a soft material. An opening 138 is formed in the base layer 130, and a mounting housing 134 is integrally formed around the opening 138 and extends inwards to accommodate the airbag 300 therein. An airbag door 200 is mounted to the base layer 130 and coupled at one end 220 thereof to the base layer 130 to close the opening 138. When the airbag cushion is deployed, the airbag door 200 cuts the outer cover layer 120 and opens.

The crash pad 100 in various embodiments of the present invention generally includes two layers, that is, the base layer 130 and the outer cover layer 120. In addition to the two layers, a coating layer 110 may be formed on the outermost portion, and other additional layers may be formed. The base layer 130 is made of a hard material and forms the basic frame for the crash pad 100. The material for the base layer 130 may include polypropylene (PP) and polyethylene (PE). The outer cover layer 120 is made of a soft material and provided to cover the base layer 130. The outer cover layer 120 is made of the soft material, thus preventing a passenger from being injured due to a collision. When the airbag cushion (not shown) is deployed, the cushion cuts the outer cover layer 120 and inflates to the outside. The material for the outer cover layer 120 may include polyurethane (PU). The outermost coating layer 110 may include thermoplastic polyurethane (TPU).

In order to mount the airbag, the mounting housing 134 is formed integrally with the base layer 130. The mounting housing 134 extends from the base layer 130 to the interior of the crash pad 100, thus forming a space in which the airbag 300 is installed. That is, the base layer 130 includes a flat portion 132 which forms a general interior panel, and the mounting housing 134 in which the airbag 300 is installed. Further, when a mounting hole 135 is formed in an end portion of the mounting housing 134 and a hook 320 is provided on the airbag 300, the hook 320 is locked to the mounting hole 135, so that the airbag 300 may be easily detached from and attached to the mounting housing 134. Since the mounting housing 134 is integrated with the base layer 130, manufacturing costs are reduced and the moving possibility of the mounting housing 134 caused by high pressure generated during the explosion of an airbag inflator is reduced, in comparison with the case where the mounting housing is separately provided. The base layer 130 is made of the hard material. Thus, even if the mounting housing 134 is made of the same material as the base layer 130, the mounting housing 134 can sufficiently perform the function of a conventional mounting housing. The airbag 300 may be mounted to the mounting housing 134 in such a way that its lower end is secured to a cowl cross member 500 through a bracket 400.

The opening 138 is formed in a portion of the base layer 130 on which the mounting housing 134 is provided. The cushion of the airbag 300 provided in the mounting housing 134 is deployed through the opening 138 to the outside.

Meanwhile, the airbag door 200 is provided on the opening 138. The airbag door 200 includes an additional panel, and one end 220 of the airbag door 200 is coupled to a rotation groove 136 of the base layer 130, so that the airbag door 200 is mounted to the crash pad 100. One end 220 of the airbag door 200 may be coupled to the base layer 130 through hinge joining or rivet joining so as to pivotally rotate with respect to a rotation axis 259.

The opening angle of airbag door 200 may be determined according to the position of the rotation axis 259, i.e., the intermediate angle between the flat portion 132 and the mounting housing 134 with respect to the rotation axis 259 may determine the opening angle of airbag door 200.

Further, the edge 240 of the airbag door 200 is inserted between the base layer 130 and the outer cover layer 120, so that the airbag door 200 is in close contact with the outer cover layer 120.

When the airbag cushion provided in the mounting housing 134 is deployed, the cushion pressures and pushes the airbag door 200, and the airbag door 200 cuts the outer cover layer 120 made of the soft material to open. As the airbag door 200 opens, the cushion inflates through the opening 138. Since the edge 240 of the airbag door 200 is supported by the base layer 130, the airbag door 200 is not pushed into the crash pad 100 when the airbag door 200 is pressed from the outside. The airbag door 200 is made of a material having proper strength, and one end 220 is coupled to the base layer 130 through hinge joining or rivet joining, thus preventing to the highest degree possible the opening force of the cushion from being lost.

Meanwhile, when the airbag 300 is deployed, large pressure acts on the mounting housing 134. When the mounting housing 134 is moved leftwards and rightwards by the pressure, the opening direction of the cushion may unfortunately change. In order to prevent this problem, a support part 133 is provided between the mounting housing 134 and the flat portion 132. A plurality of support portions 133 may be provided to support the mounting housing 134 at several points in several directions. Further, when the support portion 133 is formed integrally with the flat portion 132 and the mounting housing 134, manufacturing costs are reduced. Support portions of various shapes may be applied to the present invention.

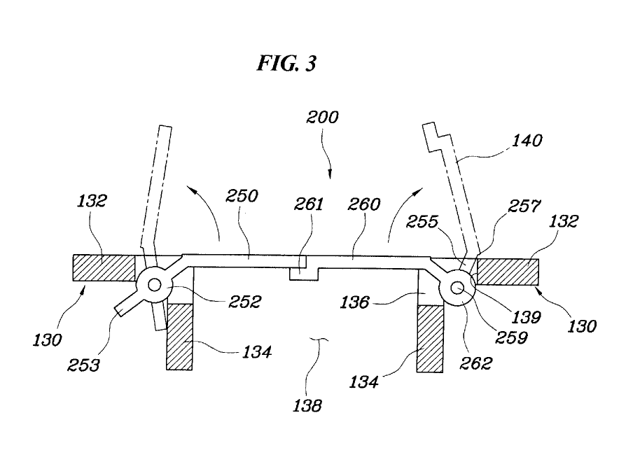

FIG. 3 is a sectional view illustrating an airbag door according to other exemplary embodiments of the present invention. According to various embodiments, the airbag door may include a plurality of rotary plates 250 and 260, each of which is pivotally coupled at one end to a base layer 130. The drawing shows a two-door-type airbag door which is constructed so that the rotary plates 250 and 260 are rotated around the opposite sides of the opening 138 when opening. Each of the rotary plates 250 and 260 is coupled at an end portion 252 or 262 to the base layer 130 through hinge joining or rivet joining. A bending structure 261 is provided on the contacting ends of the rotary plates 250 and 260, so that the rotary plates 250 and 260 are exactly coupled to each other without a gap being present there between. Further, a locking protrusion 253 is provided on the end 252 of the rotary plate 250 in such a way as to protrude out of the mounting housing 134, so that the locking protrusion 253 is stopped by the mounting housing 134 when the airbag door 200 opens, and thus the opening angle of the airbag door 20 is adjusted.

In various embodiments of the present invention, the airbag door 200 may includes an extension lever 255 so that the opening angle of the rotary plates 250 and 260 may be adjusted. For instance, the length of the extension lever 255 may be configured to be larger than a distance between the rotation center 259 of the extension lever 255 and the edge 139 of the flat portion. In this structure, the opening angle of the rotary plates 250 and 260 can be adjusted by controlling the position and length of the rotation center 259 of the extension lever 255 without the locking protrusion 253 as shown in the rotary plate 260 in FIG. 3.

The opening angle of the rotary plates 250 and 260 may be further adjusted by controlling the intermediate angle between the rotary plate 140 and the extension lever 255.

The airbag door 200 may further include a stopper protrusion 257. The stopper protrusion 257, in various embodiments of the present invention, may be formed in end portion of the extension lever 255 to prevent the rotary plates 250 and 260 from rotating more than the desired degree of opening.

When the opening angle of each of the rotary plates 250 and 260 is adjusted, it is easy to deploy the airbag cushion in a desired direction, and each of the rotary plates 250 and 260 is prevented from colliding with the windshield glass of a vehicle or with the head of a child passenger. Actually, when the airbag is deployed, the airbag door 200 collides with the windshield glass and the glass is frequently broken, so that it is very important to adjust the opening angle of the airbag door 200. Further, as for children, collision between a child's head and the airbag door 200 occurs frequently. In order to prevent such an accident, the opening ratio of the airbag door 200 is controlled.

As described above, the present invention provides a crash pad for mounting an airbag for a vehicle, in which an airbag mounting housing is integrated into the crash pad, thus reducing manufacturing costs.

Further, an airbag door is separately installed, and a cutting operation is not required, so that the opening force of an airbag cushion is not reduced, and the opening direction of the cushion does not deviate from a predetermined direction.

For convenience in explanation and accurate definition in the appended claims, the terms “outside”, “interior”, and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A crash pad for mounting an airbag for a vehicle, comprising:
a base layer made up of a first material and mounted to a vehicle body, wherein the base layer includes a flat portion and an opening;
an outer cover layer made up of a second material and covering the flat portion and the opening of the base layer so as to fasten the flat portion of the base layer to the outer cover layer;
a mounting housing extending from the flat portion of the base layer to form the opening and accommodate the airbag therein; and
an airbag door disposed between the mounting housing and the outer cover layer, the airbag door including at least a rotary plate pivotally coupled to the base layer to close the opening, wherein the airbag door is configured to cut and open the outer cover layer when the airbag inflates to push the airbag door.

2. The crash pad as set forth in claim 1, wherein the first material is harder than the second material.

3. The crash pad as set forth in claim 2, wherein the first material for the base layer comprises polypropylene or polyethylene.

4. The crash pad as set forth in claim 2, wherein the second material for the outer cover layer comprises polyurethane.

5. The crash pad as set forth in claim 1, wherein a support portion connects the flat portion and the mounting housing so as to prevent undesirable movement of the mounting housing when the airbag is deployed.

6. The crash pad as set forth in claim 1, wherein a mounting hole is formed in an end portion of the mounting housing so as to mount the airbag to the mounting housing.

7. The crash pad as set forth in claim 6, wherein a hook is installed to the airbag in a lateral side thereof and configured to be coupled to the mounting hole of the mounting housing.

8. The crash pad as set forth in claim 7, further comprising a bracket connecting a lower end portion of the airbag to a cowl cross member.

9. The crash pad as set forth in claim 1, further comprising a bracket connecting a lower end portion of the airbag to a cowl cross member.

10. The crash pad as set forth in claim 1, wherein a first end portion of the one of the at least a rotary plate door is pivotally coupled to a rotation groove formed between the mounting housing and the flat portion of the base layer to control an intermediate angle between the flat portion and the mounting housing with respect to a rotation center of the first end portion.

11. The crash pad as set forth in claim 10, wherein a locking protrusion is provided on the first end portion in such a way as to protrude out of the rotation groove and configured to be selectively engaged with the flat portion or the mounting housing, so that the locking protrusion is stopped by the mounting housing when the airbag door opens, thus controlling an opening angle of the airbag door.

12. The crash pad as set forth in claim 10, further including an extension lever extending from the first end portion to be connected with the one of the at least a rotary plate with a predetermined angle.

13. The crash pad as set forth in claim 12, wherein a stopper protrusion is formed on an end portion of the extension lever and is selectively engaged with the flat portion according a rotation of the airbag door

14. The crash pad as set forth in claim 10, wherein a second end portion of the one of the rotary plates is inserted between the flat portion of the base layer and the outer cover layer to be in close contact with the outer cover layer.

15. The crash pad as set forth in claim 10, wherein the other of the at least a rotary plate includes a first end portion pivotally coupled to the base layer, the one and the other of the at least a rotary plates being detachably coupled each other.

16. The crash pad as set forth in claim 15, wherein the first end of the other of the at least a rotary plate is pivotally coupled to a rotation groove formed between to the mounting housing and the flat portion of the base layer to control an intermediate angle between the flat portion and the mounting housing with respect to a rotation center of the first end portion.

17. The crash pad as set forth in claim 15, wherein a locking protrusion is provided on the first end portion in such a way as to protrude out of the rotation groove and configured to be selectively engaged with the flat portion or the mounting housing, so that the locking protrusion is stopped by the mounting housing when the airbag door opens, thus controlling an opening angle of the airbag door.

18. The crash pad as set forth in claim 15 further including an extension lever extending from the first end portion to be connected with the other of the at least a rotary plate with a predetermined angle.

19. The crash pad as set forth in claim 18, wherein a stopper protrusion is formed on an end portion of the extension lever and is selectively engaged with the flat portion according a rotation of the airbag door
